(19) United States
(12) Patent Application Publication
(10) Pub. No.: US 2011/0214267 A1
(43) Pub. Date: Sep. 8, 2011

(54) TOOL DEVICE AND MACHINE TOOL

(75) Inventor: Martin Schmid, Kirchheim/Teck (DE)

(73) Assignee: MAG IAS GmbH

(21) Appl. No.: 13/050,193

(22) Filed: Mar. 17, 2011

Related U.S. Application Data
(63) Continuation of application No. PCT/EP2009/061968, filed on Sep. 15, 2009.

(30) Foreign Application Priority Data
Sep. 18, 2008 (DE) 10 2008 049 520.4

(51) Int. Cl. B23Q 5/26; B23P 23/02

(52) U.S. Cl. 29/56.5; 29/57

(57) ABSTRACT

A tool device for a machine tool is provided comprising at least one interface for fluid, at least one piston device having a first piston face in fluid connection with the at least one interface for fluid and a second piston face opposite the first piston face, a return motion device which acts upon the first piston face, and a workpiece machining device coupled to the at least one piston device, wherein the at least one piston device is movable and positionable by force-biasing via the fluid.

### CROSS-REFERENCE TO RELATED APPLICATIONS

This application is a continuation of International Patent Application Number PCT/EP2009/061968, filed Sep. 15, 2009, which claims priority to German Patent Application No. 10 2008 049 520.4, filed Sep. 18, 2008, both of which are incorporated herein by reference in their entirety.

### FIELD OF THE INVENTION

The invention relates to a tool device for a machine tool. The invention further relates to a machine tool comprising at least one tool carrier.

### BACKGROUND OF THE INVENTION

In German Patent Application DE 10 2007 045 045 A1 (not pre-published), a machine tool is disclosed having a tool carrier with a carrier-side coolant/lubricant interface to supply a honing tool with a coolant/lubricant mixed with water.

WO 2006/136361 A1 discloses a valve seat and valve guide machining tool for fine-machining a valve seat and a valve guide in a cylinder head of an internal-combustion engine. Said tool comprises at least two partial tools, wherein a first partial tool has at least one geometrically defined cutting edge and is associated with machining the valve seat. A second partial tool has at least one geometrically defined cutting edge and is associated with machining the valve guide.

The catalogue “MAPAL/ISOTOOL, Aussteuerwerkzeuge und Plandrehköpfe, Vorabexemplar METAV 2006” (“MAPAL/ISOTOOL, Actuating Tools and Facing Heads, METAV 2006 (advance copy)”) describes a taper-turning tool for valve seats and valve guides which can be used for turning valve seats and reaming valve guide holes. The sleeve moves independently of the feed motion of the basic tool.

DE 37 37 024 A1 discloses a drilling device, in particular for core drilling, consisting of a drill stand with foot and drive. Arranged on a foot is a stand configured as a pressure cylinder which encloses a guide shaft with centring tip, a drill shank with drill crown, a feed device, and a cooling device, and has a plate with drive unit detachably mounted on one end face thereof and a sealing device provided on the opposite end thereof.

DE 198 59 051 A1 discloses a tool for machining a workpiece by a chip-producing method to generate a non-planar surface, in particular for a valve seat, including a basic body having at least one cutter plate received in a holder, a partial tool displaceable with respect to the basic body, and an actuating device cooperating with the holder via a coupling device. The coupling device comprises an eccentric which is rotatable about an axis offset from the centre axis of the tool by means of the actuating device.

### SUMMARY OF THE INVENTION

In accordance with an embodiment of the invention, a tool device for a machine tool is provided which allows a workpiece to be machined in a simple manner, for example via a feed (advance) motion.

In accordance with an embodiment of the invention, the tool device comprises at least one interface for fluid, at least one piston device having a first piston face in fluid connection with the at least one interface for fluid and a second piston face opposite the first piston face, a return motion device which acts upon the second piston face, and a workpiece machining device coupled to the at least one piston device, wherein the at least one piston device is movable and positionable by force-biasing via the fluid.

The solution in accordance with the invention allows a workpiece to be machined in a fluid-controlled manner. The at least one piston device can be moved in a fluid-controlled manner. For example, an already existing interface for coolant, lubricant or compressed air can be used for a feed motion of a workpiece machining device.

The return motion device provides a return force which allows a piston device to be returned in a simple manner following an advance motion. The initial position of the piston device (no fluid-biasing) is preferably defined by the return motion device.

The tool device can be configured in a simple and compact manner. In particular, there is no need to provide an additional electrical power connection. Movement of the piston device can be accomplished independently of the motion of a tool carrier holding the tool device. It is also possible to use a plurality of piston devices on one tool device in order, for example, to provide a combination tool.

For example, it is then possible, via a tool device, to machine a valve guide and to machine a valve seat on a workpiece without reclamping the workpiece. It is, for example, also possible to use a corresponding combination tool to accomplish rough-machining and fine-machining on a workpiece in the same clamping.

For example, the workpiece machining device comprises a tool region for turning, reaming, drilling/boring, parting, facing or threading. This makes it possible to perform a wide range of machining operations, depending on the design of the tool device. A corresponding machine tool and in particular a machining center is, therefore, adapted to a variety of uses.

It is advantageous for the at least one piston device to be linearly movable. The tool device can thereby be configured in a simple manner.

It is advantageous for a movement axis of a linear motion capability of the at least one piston device to be parallel to or coaxial with an axis of rotation of the tool device as a whole. A tool device having an internal feed motion capability can thereby be implemented in a simple manner, the tool device being rotatable as a whole.

In particular, the first piston face and/or the second piston face is oriented transversely and in particular perpendicularly to a movement axis of a linear motion capability of the at least one piston device. This results in an optimized control capability, and in particular fluid control capability, of the movement and positioning of the piston device.

In the solution in accordance with the invention, the movement and/or positioning of the at least one piston device is fluid-controlled. This allows an already existing interface for coolant or compressed air to be utilized for moving and/or positioning the at least one piston device and, with it, a tool region which performs the actual machining of the workpiece.

The at least one interface for fluid is in particular an interface for coolant or compressed air.

It is advantageous for fluid provided via the at least one interface for fluid to exert a pressure force for moving and positioning the at least one piston device, the return motion device providing a force counteracting this force. For example, when the provision of fluid is turned off or the pressure in the fluid is reduced, then the return motion device automatically provides for a return motion.

It is advantageous for the workpiece machining device to be movable by the at least one piston device. This enables a defined workpiece machining operation to be performed. For example, machining via a reaming or parting operation can be performed.

It can be provided for the workpiece machining device to be adapted to be given an infeeding movement by the at least one piston device. For example, this enables a turning operation to be performed. For example, a chamfer on a valve seat can thereby be produced in a simple manner.

In an embodiment or in a tool device, the workpiece machining device can be held by the at least one piston device. A movement of the corresponding piston device thereby directly translates in a corresponding movement of the workpiece machining device.

It is also possible for the workpiece machining device to be movable, by action of the at least one piston device, in a linear movement direction which is at an acute angle to a linear movement direction of the at least one piston device. In this case, the piston device constitutes a direct drive for the workpiece machining device. An infeed motion of the workpiece machining device towards an axis of the tool device can thereby be implemented in a simple manner, wherein the corresponding tool device can be configured with small diameter dimensions.

In particular, the workpiece machining device is then held or formed on a guide device whose movement and positioning are controlled by the at least one piston device. The piston device is movable and positionable by direct fluid control. This movement and positioning directly causes movement and positioning of the guide device.

It is advantageous for the guide device to have a return motion device. For example, it is thereby possible to provide for the guide device and the piston device to be slidingly guided on one another. When the piston device is moved back (which, in principle, can result in a loss of contact), then the return motion device can provide for the guide device to be urged against the piston device, thereby preventing the loss of sliding contact.

In an embodiment favorable in terms of design, the at least one piston device has a first ramp face and the guide device has a second ramp face, wherein the first ramp face acts upon the second ramp face and the first ramp face and the second ramp face are oriented at an acute angle relative to a linear movement direction of the at least one piston device. Preferably, the first ramp face and the second ramp slide against each other. A direction of movement can be changed via the ramp face; the direction of movement of the piston device can be converted to a direction of movement of the guide device which is at an angle to the direction of movement of the piston device.

It is advantageous for the return motion devices to comprise one or more springs, in particular mechanical springs. A return action can thereby be achieved in a simple manner. With an appropriate selection of the spring force, it is thereby also possible for the at least one piston device to be automatically in an initial position and for active fluid-biasing to be required in order to achieve an advance motion away from this initial position.

In an embodiment, a combination tool is formed by having a first piston device which is in fluid connection with a first interface for fluid and to which a first workpiece machining device is coupled and by having a second piston device which is in fluid connection with a second interface for fluid and to which a second workpiece machining device is coupled. This enables different machining operations to be performed, in particular successively, on the same workpiece via the first workpiece machining device and the second workpiece machining device. For example, it is possible to carry out a valve guide machining operation and a valve seat machining operation in succession and on the same workpiece. Workpiece machining can then be performed in the same clamping. This allows the position movements of the workpiece or of a workpiece carrier to be minimized. Workpiece machining can thereby be effected in a time-saving manner. High accuracy can also be achieved.

It can be provided for the second piston device to surround the first piston device. A tool device with small dimensions can thereby be implemented.

In an exemplary embodiment, the first workpiece machining device is configured for machining a valve guide and/or the second workpiece machining device is configured for machining a valve seat. For example, the first workpiece machining device then comprises a reaming tool for fine-machining valve guides. The second workpiece machining device comprises one or more geometrically defined cutting edges for performing turning work on a valve seat and in particular for producing chamfers on the valve seat.

A further object underlying the invention is to provide a machine tool of the type indicated at the outset which is universal in application.

In accordance with the invention, this object is achieved with the machine tool indicated at the outset in that it comprises at least one tool carrier which comprises at least one interface for fluid and on which a tool device in accordance with the invention is held, wherein the at least one interface for fluid of the at least one tool carrier is in fluid connection with the at least one interface for fluid of the tool device.

In the solution in accordance with the invention, a feed motion of a tool can be achieved in a simple manner via the tool device, wherein the drive of the feed motion is fluid-controlled. The feed motion can thereby be effected without relative movement of the tool carrier and the workpiece.

The machine tool in accordance with the invention has the advantages mentioned in connection with the tool device in accordance with the invention.

In particular, the at least one interface for fluid of the at least one tool carrier is an interface for coolant, lubricant or compressed air.

Preferably, the at least one tool carrier is configured as a tool spindle on which a fixed tool device is rotatable about an axis of rotation. The tool device can thereby be rotated as a whole. Inside the tool device, a feed motion of a tool region can be implemented via a fluid-controlled piston device.

Preferably, the at least one tool carrier is linearly movable in at least one direction relative to a workpiece carrier.

A tool device in accordance with the invention and a machine tool in accordance with the invention can be used advantageously for machining valve guides and valve seats.

The following description of preferred embodiments, taken in conjunction with the drawings, serves to explain the invention in greater detail.

### BRIEF DESCRIPTION OF THE DRAWINGS

FIG. 1 shows, in top view, an exemplary embodiment of a machine tool in accordance with the invention (with the workspace enclosure removed);

FIG. 2 is a schematic sectional view of an exemplary embodiment of a tool device in accordance with the invention; and

FIG. 3 is a schematic representation of a valve assembly on an internal-combustion engine.

### DETAILED DESCRIPTION OF THE INVENTION

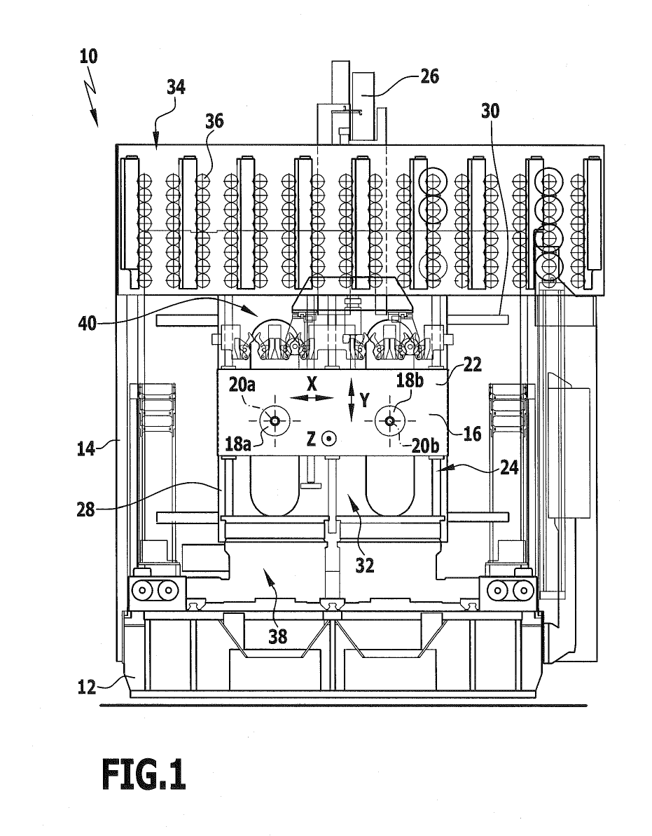

An exemplary embodiment of a machine tool in accordance with the invention is a machining centre. An embodiment of a machining centre, shown in the partial schematic view of FIG. 1 and indicated therein by 10, comprises a machine bed 12 on which a machine frame 14 is arranged. The machine frame 14 is of portal-type construction and projects beyond the machine bed 12 in a vertical direction (relative to the direction of gravity). Held on the machine frame 14 is a tool carrier device 16 comprising at least one tool carrier 18.

In the exemplary embodiment shown, the tool carrier device 16 comprises a first tool carrier 18a and a second tool carrier 18b. The tool carriers 18a and 18b are configured as tool spindles. A tool held on the respective tool carrier 18a, 18b is rotatable about an axis of rotation 20a, 20b. In the illustration of FIG. 1, the axes of rotation 20a, 20b are parallel to one another. They are oriented parallel to a direction Z which is perpendicular to the drawing plane of FIG. 1. The direction Z is in particular a horizontal direction relative to the direction of gravity.

The tool carrier device 16 is configured as a carriage which is held on a carriage guide 24 and linearly movable in a direction Y (direction and counter-direction) via the carriage guide 24. The direction Y is transverse and in particular perpendicular to the direction Z. The direction Y is in particular a vertical direction relative to the direction of gravity.

The carriage 22 has a drive device 26 associated with it for driving the movement of the carriage 22 in the direction Y and for its positioning. This drive device may, for example, comprise a ball screw or a linear motor.

The carriage 22 is itself held on a carriage 28 which is linearly displaceable in a direction X (direction and counter-direction) on a carriage guide 30. A corresponding drive is provided for its displacement and positioning. The direction X is transverse and in particular perpendicular to the direction Y and the direction Z. The direction X is in particular a horizontal direction relative to the direction of gravity.

The tool carrier device 16 is thereby movable in the direction X and in the direction Y relative to the machine frame 14.

Arranged on the machine bed 12 is (at least) one workpiece carrier 32. The first tool carrier 18a and the second tool carrier 18b (and, with them, any tools held thereon) and the workpiece carrier 32 are movable in the direction Z (direction and counter-direction) relative to one another. In one exemplary embodiment, the tool carriers 18a, 18b are not movable in the direction Z for workpiece machining and the workpiece carrier 32 is held for displacement in the direction Z on the machine bed 12. To this end, the workpiece carrier 32 has a drive associated with it. In an alternative exemplary embodiment, the first tool carrier 18a and the second tool carrier 18b are held for displacement on the tool carrier device 16 in order to enable Z-displaceability.

It is also possible to combine a Z-displaceability of the tool carriers 18a, 18b on the tool carrier device 16 and a Z-displaceability of the workpiece carrier 32 on the machine bed 12.

For example, it can also be provided for the workpiece carrier 32 to be rotatable about a (for example) vertical axis.

In the exemplary embodiment shown, the machining centre 10 has a magazine device 34 for tools 36, which is arranged above a workspace 38 in which workpieces are machined.

Further, a tool changing device 40 is provided via which tools are insertable on and removable from the tool carriers 18a and 18b.

It is also possible for the machining centre 10 to comprise only a single tool carrier or to comprise more than two tool carriers.

A respective tool carrier 18 has an interface 42 for fixing a tool device 44. The interface 42 is, for example, configured as a HSK (“hollow taper shank”) interface. The tool device 44 is rotatable as a whole about an axis of rotation 46 via the corresponding tool carrier 18.

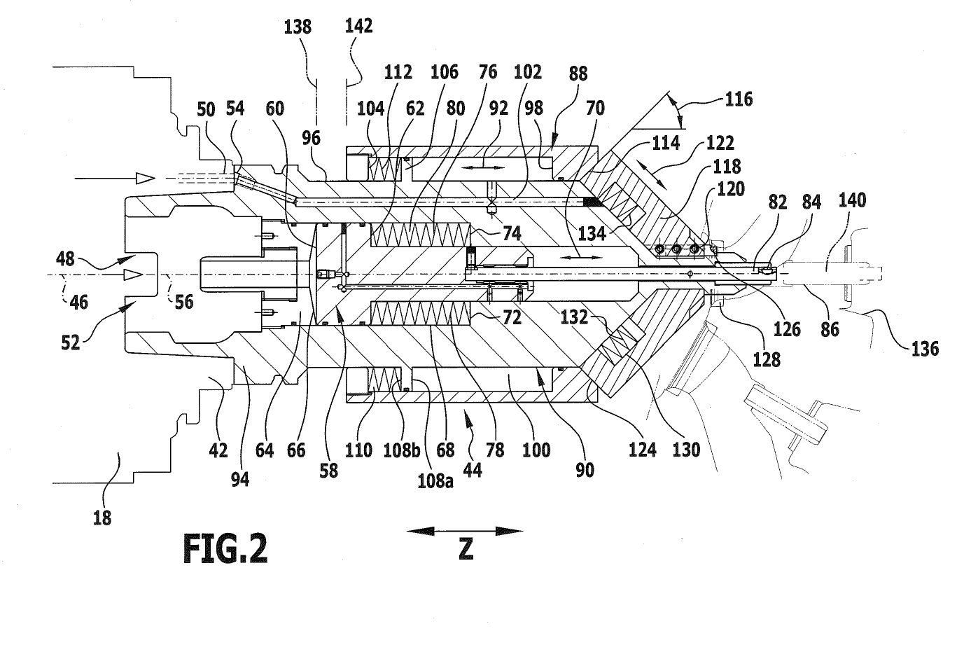

A tool carrier 18 further comprises (at least) one interface for fluid. As used herein, the term “fluid” generally means any flowable substance. Examples of fluids are coolant, lubricant and compressed air. In an exemplary embodiment of a tool device 44 in accordance with the invention (FIG. 2), a first interface 48 for fluid and a second interface 50 for fluid are provided. The first interface 48 is, for example, an interface for coolant (which may also have a lubricant function) which can be provided to the tool device 44 via said first interface 48. The second interface 50 is, for example, an interface for compressed air via which the tool device 44 can be provided with compressed air.

Correspondingly, the tool device 44 has a first interface 52 for fluid and a second interface 54 for fluid. The first interface 48 of the tool carrier 18 is adapted to be fluidly connected to the first interface 52 of the tool device 44. Further, the second interface 50 of the tool carrier 18 is adapted to be coupled to the second interface 54 of the tool device 44. The first interface 48 and the second interface 50 are preferably configured such that they can be used for fluid control of the tool device 44.

The tool device 44 has an axis 56 which, with the tool device 44 fixed to the tool carrier 18, is coaxial with the axis of rotation 46.

The tool device 44 comprises a first piston device 58 having a first piston face 60 and a second piston face 62 opposite the first piston face. The first piston face 60 is in fluid connection with the first interface 52 for fluid. The second piston face 62 is fluidly isolated from said first interface 52.

Upstream of the first piston face 60 is a fluid distribution space 64 via which pressure-biasing of the first piston face 60 is realized via fluid which is provided via the first interface 48 of the tool carrier 18. The first interface 52 for fluid has an opening which opens into the fluid distribution space 64.

Upstream of the first piston face 60 is a membrane 66 which prevents fluid from biasing the first piston face 60 directly.

The first piston device 58 is guided for linear displacement on a guide device 68. A linear movement direction 70 (direction and counter-direction) is parallel to or coaxial with the axis 56 and, therefore, parallel to or coaxial with the axis of rotation 46.

The guide device 68 is, for example, formed by a piston receptacle 72. The piston receptacle 72 has an end wall 74 facing away from the first piston face 60 and facing the second piston face 62. Arranged between the end wall 74 and the second piston face 62 is a return motion device 76 which exerts on the second piston face 62 a force oriented in a direction from the second piston face 62 towards the first piston face 60, parallel to the axis 56. Fluid which is coupled-in via the first interface 52 exerts on the first piston face 60 a force oriented in a direction from the first piston face 60 towards the second piston face 62, parallel to the axis 56.

The return motion device 76 is in particular configured as an elastic device and comprises one or more mechanical springs, wherein a spring, when provided, rests against the end wall 74 and the second piston face 62.

For example, in principle it is also possible for the return motion device 76 to be configured as a gas spring.

A space 80 in which the return motion device 76 is arranged is isolated from the fluid distribution space 64 in a fluid-tight manner.

The first piston device 58 holds a first workpiece machining device 82 via which workpiece machining is effected. The workpiece machining device 82 is the actual tool that acts on a workpiece directly and mechanically.

The workpiece machining device comprises a tool region 84. This tool region 84 is rotatable about the axis of rotation 46 via rotation of the tool carrier 18. It is displaceable in the linear movement direction 70 via the linear motion capability of the first piston device 58.

The tool region 84 is, for example, a tool region for performing turning, reaming, drilling/boring, parting, facing or threading work on a workpiece.

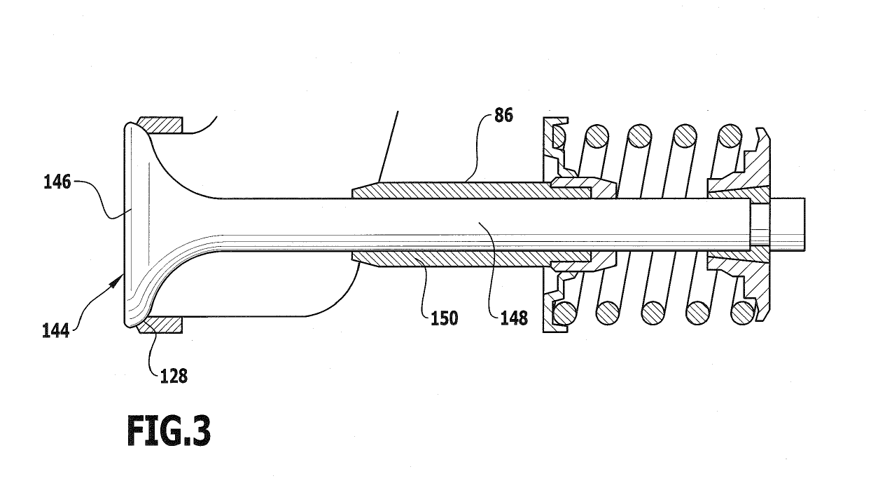

In the exemplary embodiment illustrated in FIG. 2, the tool region is a reaming tool region. For example, such a reaming tool region enables valve guides 86 (FIG. 2, FIG. 3) to be machined.

The first interface 48 and also the first interface 52 are preferably configured such that the tool region 84 can be supplied with coolant.

In the first piston device 58, the first workpiece machining device 82 is held on the piston device in fixed manner, being aligned at least approximately coaxial with the axis 56. By being fixed to the first piston device 58, the first workpiece machining device 82 directly follows each movement of the first piston device 58.

The tool device 44 further comprises a second piston device 88. This surrounds the first piston device 58.

The second piston device 88 is guided for displacement in a linear movement direction 92 (direction and counter-direction) on a guide device 90. The linear movement direction 92 is parallel to the linear movement direction 70.

The guide device 90 is, for example, configured as an outer guide; the first piston device 58 is arranged in a housing 94, and an outer side 96 of the housing or a device directly connected with the outer side 96 forms a sliding face for the second piston device 88.

The second piston device 88 has a first piston face 98 which is in fluid connection with the second interface 54 of the tool device 44. A fluid distribution space 100 is formed upstream of the first piston face 98. For example, a fluid conduit 102 is routed from the second interface 54 into the fluid distribution space 100 in order to enable fluid to be coupled into the fluid distribution space and cause pressure-biasing of the first piston face 98 for moving and positioning the second piston device 88.

The second piston device has a second piston face 104. A stationary wall 106 is arranged between the second piston face 104 and the first piston face 98. Said wall has a first side 108a facing the first piston face 98 and a second side 108b facing the second piston face 104. The wall 106 is arranged at the housing 94, oriented in a direction transverse and in particular perpendicular to the axis 56. The first side 108a of the wall 106 (together with the first piston face 98) delimits the fluid distribution space 100. The fluid conduit 102 opens into the fluid distribution space 100 at a position between the first piston face 98 and the wall 106 such that coupling-in of fluid into the fluid distribution space 100 is possible in each position of the second piston device 88.

Formed between the second side 108b and the second piston face 104 is a space 110 in which a return motion device 112 is arranged. The return motion device 112 provides a force having a direction of force directed away from the first piston face 98 and towards the second piston face 104. A pressure force of the fluid in the fluid distribution space 100 acts in a direction away from the second piston face 104 and towards the first piston face 98.

The return motion device 112 is in particular configured as an elastic device and comprises one or more mechanical springs. A spring, when provided, rests against the second side 108b of the wall 106 and the second piston face 104.

It is, in principle, also possible for the return motion device 112 to be configured as a gas spring, for example.

The second piston device 88 has a first ramp face 114 at a front side thereof (facing away from the tool carrier 18). Said ramp face is oriented at an acute angle 116.

A guide device 118 is provided which holds a second workpiece machining device 120. The guide device 118 is linearly displaceable in a linear movement direction 122. The linear movement direction 122 is at an acute angle relative to the linear movement direction 92, said acute angle corresponding in terms of its amount to the angle 116.

The guide device 118 has a second ramp face 124 which is oriented at the acute angle 116 relative to the linear movement direction 92 and is aligned parallel to the first ramp face 114. When the second piston device 88 advances, the first ramp face 114 acts upon the second ramp face 124 of the guide device 118. This causes the guide device 118, together with the second workpiece machining device 120, to be displaced in the linear movement direction 122 in a direction towards the axis 56. This enables infeeding of the second workpiece machining device 120 with a corresponding tool region 126 to a workpiece. For example, this allows a turning operation to be performed on a workpiece.

The second ramp face 124 is slidingly supported on the first ramp face 114 with lubrication being provided via coolant for example. Correspondingly, provision is made for supplying coolant to the sliding faces.

For example, a valve seat 128 (FIGS. 2, 3) can be machined.

The second piston device 88 is not connected rigidly to the guide device 118 but, in a sense, pushes it via action of the first ramp face 114 upon the second ramp face 124.

The guide device 118 comprises a return motion device 130. For example, the return motion device 130 comprises one or more mechanical springs 132. A corresponding spring 132 rests against the movable guide device 118 and also has a rest 134 which is fixed, i.e. immobile, relative to the housing 94.

The return motion device 130 causes movement of the guide device 118 (and, with it, of the tool region 126) away from the axis 56 once the second piston device 88 no longer has a pushing force on the guide device 118.

The tool device 44 in accordance with the invention operates as follows:

The tool device 44 can be detachably fixed to the tool carrier 18 via the mechanical interface 42. When fixing the tool device, the first interfaces 48 and 52 and the second interfaces 50 and 54 are connected. This enables fluid exchange between the machine tool and the tool device 44 via the tool carrier 18.

For example, in an exemplary embodiment, coolant under a pressure of the order of magnitude of, for example, 40 bar is provided via the first interface 48. Compressed air is provided via the second interface 50. The fluid-biasing of the first piston device 58 and the second piston device 88 is controllable.

Once fixed, the tool device 44 is rotatable as a whole about the axis of rotation 46 in order to enable machining of the workpiece. With the machining centre 10, a capability for relative movement in a direction Z between the tool device 44 and a workpiece 136 is provided.

With no fluid-biasing of the first piston face 60 of the first piston device 58, the first piston device 58 is located in a first position 138. The first position 138 is predetermined via the return motion device 76 and a stop at which the return motion device 76 pushes on the first piston device 58.

By fluid-biasing of the first piston face 60 via the first interface 52, a fluid-controlled movement and positioning of the first piston device 58 and, with it, of the first workpiece machining device 82 can be achieved. This allows the first piston device 58 to be put in one or more machining positions, wherein the movement of the first piston device 58 in a forward direction away from the first position 138 can itself be a machining operation, such as a parting or reaming operation.

FIG. 2 schematically indicates a second position 140 resulting from displacement of the first piston device 58 from the first position 138.

In order for advance motion to be achieved, the pressure force resulting from fluid-biasing of the first piston face 60 has to overcome the return force of the return motion device 76 and any counter-forces resulting from workpiece machining. If the pressure force of the fluid-biasing is lower than the resultant of these forces, the first piston device 58 is displaced back to the first position 138.

The second piston device 88 can be moved independently of the first piston device 58. The second piston device 88 has a first position 142 which is defined by a return force of the return motion device 112 and a corresponding stop of the second piston device 88.

The guide device is displaced via the return motion device 130 until the second ramp face 124 abuts against the first ramp face 114, or, in a corresponding return movement of the second piston device 88, the guide device 118 follows this movement, wherein the first ramp face 114 defines a contact face.

When the fluid distribution space 100 is biased by fluid (for example compressed air), in particular in a controlled manner, then a corresponding force is exerted on the first piston face 98 which pushes the second piston device 88 in a forward direction away from the first position 142. By the inclined configuration of the first ramp face 114 and abutment thereof against the second ramp face 124, the guide device 118 is displaced in the linear movement direction 122, thereby effecting infeeding of the tool region 126 towards the axis 56. A corresponding workpiece machining operation can thereby be realized.

The pressure force exerted on the first piston face 98 via fluid has to be large enough to overcome the sum of the return force of the return motion device 112 and any counter-forces resulting from workpiece machining.

When, after completion of the machining operation, the pressure force is reduced (by corresponding control of the fluid-biasing) and falls below the largest return force, the second piston device 88 is then displaced back to the first position 142 and, with it, the tool region 126 is displaced away from the axis 56.

A tool device 44 in accordance with the invention enables, for example, valve guides 86 and valve seats 128 to be machined in one clamping on a machining centre 10.

Valves 144 of an internal-combustion engine have a valve head 146 which rests on a valve seat 128 when the valve is closed.

Arranged on the valve head 146 is a valve rod 148. This is guided in a valve guide 86, wherein the valve guide 86 can have a sleeve 150 arranged therein in which the valve rod 148 is guided.

For example, a valve guide 86 can be machined, and in particular fine-machined, via the first workpiece machining device 82.

After completion of machining of the valve guide 86, the valve seat 128 can be machined, and in particular fine-machined, via the second workpiece machining device 120. This can be performed in the same clamping, so that time-saving and also accurate machining is possible.

In the exemplary embodiment shown, the tool device 44 is a combination machining tool device via which at least two machining operations can be performed on a workpiece.

In principle, a multiplicity of different machining operations can be performed, said operations being performed successively. For example, it is possible to initially perform a rough-machining operation and then to perform a fine-machining operation. For example, as mentioned above, it is possible to machine a valve guide, for example via a reaming tool, and to subsequently turn a valve seat to an angle.

Via the tool carrier 18, the machine tool provides fluid for the fluid control of the first workpiece machining device 82 and the second workpiece machining device 120 in their respective linear motion capability. The already existing first interface 48 and second interface 50 of the tool carrier 18 can thereby be utilized in order to attain feed motion and infeed motion of the tool regions 84 and 126 respectively. The tool device 44 can be configured in a correspondingly simple manner because there is no need to provide the tool device 44 with an active drive having an electrical power supply of its own; it is possible to utilize already existing interfaces, for example for coolant and/or compressed air.

The linear motion of the first piston device 58 and the second piston device 88 is performed independently of a possible Z-motion of the tool carrier 18 relative to the workpiece.

In principle, it is also possible, via an interpolated method, to implement angular adjustment during machining.

1. Tool device for a machine tool, comprising:
at least one interface for fluid;
at least one piston device having a first piston face in fluid connection with the at least one interface for fluid and a second piston face opposite the first piston face;
a return motion device which acts upon the first piston face; and
a workpiece machining device coupled to the at least one piston device;
wherein the at least one piston device is movable and positionable by force-biasing via the fluid.

2. Tool device in accordance with claim 1, wherein the workpiece machining device comprises a tool region for turning, reaming, drilling/boring, parting, facing or threading.

3. Tool device in accordance with claim 1, wherein the piston device is linearly movable.

4. Tool device in accordance with claim 1, wherein a movement axis of a linear motion capability of the at least one piston device is parallel to or coaxial with an axis of rotation of the tool device as a whole.

5. Tool device in accordance with claim 1, wherein at least one of the first piston face and the second piston face is oriented transversely to a movement axis of a linear motion capability of the at least one piston device.

6. Tool device in accordance with claim 1, wherein at least one of the movement and positioning of the at least one piston device is fluid-controlled.

7. Tool device in accordance with claim 1, wherein the at least one interface for fluid is an interface for coolant, lubricant, or compressed air.

8. Tool device in accordance with claim 1, wherein fluid provided via the at least one interface for fluid exerts a pressure force for moving and positioning the at least one piston device and the return motion device provides a force counteracting this force.

9. Tool device in accordance with claim 1, wherein the workpiece machining device is movable by the at least one piston device.

10. Tool device in accordance with claim 1, wherein the workpiece machining device is movable into engagement by the at least one piston device.

11. Tool device in accordance with claim 1, wherein the workpiece machining device is held by the at least one piston device.

12. Tool device in accordance with claim 1, wherein the workpiece machining device is movable, by action of the at least one piston device, in a linear movement direction which is at an acute angle to a linear movement direction of the at least one piston device.

13. Tool device in accordance with claim 12, wherein the workpiece machining device is held or formed on a guide device whose movement and positioning are controlled by the at least one piston device.

14. Tool device in accordance with claim 13, wherein the guide device has a return motion device.

15. Tool device in accordance with claim 13, wherein the at least one piston device has a first ramp face and the guide device has a second ramp face, wherein the first ramp face acts upon the second ramp face and the first ramp face and the second ramp face are oriented at an acute angle relative to a linear movement direction of the at least one piston device.

16. Tool device in accordance with claim 1, wherein the return motion device comprises one or more springs.

17. Tool device in accordance with claim 1, comprising a first piston device which is in fluid connection with a first interface for fluid and to which a first workpiece machining device is coupled, and a second piston device which is in fluid connection with a second interface for fluid and to which a second workpiece machining device is coupled.

18. Tool device in accordance with claim 17, wherein the second piston device surrounds the first piston device.

19. Tool device in accordance with claim 17, wherein the first workpiece machining device is configured for machining a valve guide.

20. Tool device in accordance with claim 17, wherein the second workpiece machining device is configured for machining a valve seat.

21. Machine tool, comprising:
at least one tool carrier which comprises at least one interface for fluid and on which a tool device is held;
wherein the at least one interface for fluid of the at least one tool carrier is in fluid connection with the at least one interface for fluid of the tool device; and
wherein the tool device comprises:
at least one interface for fluid;
at least one piston device having a first piston face in fluid connection with the at least one interface for fluid and a second piston face opposite the first piston face;
a return motion device which acts upon the first piston face; and
a workpiece machining device coupled to the at least one piston device;
wherein the at least one piston device is movable and positionable by force-biasing via the fluid.

22. Machine tool in accordance with claim 21, wherein the at least one interface for fluid of the at least one tool carrier is an interface for coolant, lubricant or compressed air.

23. Machine tool in accordance with claim 21, wherein the at least one tool carrier is configured as a tool spindle on which a fixed tool device is rotatable about an axis of rotation.

24. Machine tool in accordance with claim 21, wherein the at least one tool carrier is linearly movable in at least one direction relative to a workpiece carrier.
